(19) United States
(12) Patent Application Publication
(10) Pub. No.: US 2008/0170837 A1
(43) Pub. Date: Jul. 17, 2008

(54) INFORMATION PROCESSING SYSTEM

(75) Inventor: Stuart Antony GREEN, Sheffield (GB)

Correspondence Address: BAINWOOD HUANG & ASSOCIATES LLC, 2 CONNECTOR ROAD, WESTBOROUGH, MA, 01581, US

(73) Assignee: ZOOTECH LIMITED, Sheffield (GB)

(21) Appl. No.: 11/972,955

(22) Filed: Jan. 11, 2008

Related U.S. Application Data
(60) Provisional application No. 60/880,129, filed on Jan. 12, 2007.

(51) Int. Cl. H04N 5/91

(52) U.S. Cl. 386/94

(57) ABSTRACT

Aspects and embodiments of the present invention relate to copy protection of media products. Exemplary media products are DVD products and the like. According to some embodiments, such media products (745) may carry, in a data area (740), presentation data (325), navigation data (330) and read barriers (AV3), the navigation data (330) providing a plurality of selectable playback paths and providing selection logic (SLn) for selecting a playback path during playback of the product. At least one selectable playback path (MP2) of the product encounters a read barrier (AV3) and at least one other selectable playback path (MP1) does not encounter a read barrier.

### CROSS-REFERENCE TO RELATED APPLICATIONS

This application claims the benefit under 35 U.S.C. § 119(e) of U.S. Provisional Application No. 60/880,129 filed Jan. 12, 2007, the disclosure of which is hereby incorporated by reference.

### BACKGROUND OF THE INVENTION

The present invention is in the field of copy-protection of media products and the like. In particular, but not exclusively, aspects and embodiments of the present invention relate to copy protection of optical disc products, such as, for example, DVD-Video disc products and the like.

Optical discs such as compact disc (CD) and digital versatile disc (DVD) are well known.

For nearly as long as data-carrying optical discs have been sold, they have also been copied illegally, sometimes on a commercial scale. Such copying is typically facilitated by copying software, which is often referred to as ‘ripping’ software, which executes on a personal computer (PC). The ripping software is typically operable to read the data from a disc and write it to one or more blank discs. As a result, many kinds of copy protection techniques have been devised to make copying more difficult.

One kind of copy protection solution is described in U.S. Pat. No. 5,787,068 (Imation Corp.). This solution produces optical discs with physical, unreadable barriers (for example, pits or bumps) in certain content sectors or zones of a disc. The disc has addressing information, which identifies the content to be read, and the addressing information dictates that the barriers are not accessed when the disc plays normally. However, if the disc is inserted into a disc drive in a PC, and a ripping program is used to copy the data, any attempt to read the entirety of the original disc will encounter the barriers, which will result in read errors. Such read errors at best cause the disc read to fail, or at the very least incur a significant delay in the processing of the data, and, if a large number of these sectors is encountered, the total processing time will be excessive, thereby defeating the copying process.

A key teaching of Imation is to provide an anti-ripping solution through the insertion of ‘barriers’ on optical media where such barriers are located in parts of the media that will not play during normal playback. The implementation of barriers described by Imation is a physical change in the structure of the tracks containing the pits that encode the digital signal but could equally be applied to other ways of incorporating non-compliant structures. Indeed others have observed that such barriers can be effectively provided on DVD-Video by corrupting the logical data in the sectors rather than by providing a physical corruption.

For example, EP 1 528 557 (Sony DADC Austria AG) and EP 1 566 803 (Macrovision Corporation—hereinafter “MV1”) describe solutions that adopt the principles taught by Imation, whereby unreadable barriers are placed on a disc to prevent sequential copying of content data. However, instead of using ‘physical’ barriers, they provide ‘logical’ barriers in the form of corrupt data, which is difficult for ripping software to read. Examples of logical barriers are incorrect checksums and inconsistent error detection and recovery fields, which are incorporated in the logical file system data structures of an optical disc such as a DVD. In addition, as in Imation, both Sony and MV1 provide control data that prevents the logical barriers from being read during legitimate playback. In principle at least, the Sony and MV1 solutions are equivalent to the Imation solution.

The advent of anti-ripping solutions such as Imation, Sony and MV1 has led to more sophisticated ripping software that operates by interrogating addressing and control data. In particular, some ripping software is arranged to parse the addressing or control data and then only read and copy content that is addressed by the addressing or control data. Thus, the physical or logical barriers, which are avoided during legitimate playback, can also be avoided by such ripping software, and copying can take place.

EP 1 600 963 (Macrovision Corporation—hereinafter “MV2”) describes a modified anti-ripping solution for DVD optical discs, wherein redundant control data is provided including logical barriers therein, which prevents parsing of the redundant control data by ripping software, thereby increasing the difficulty of copying the content data. The redundant control data is not accessed during legitimate playback of the DVD. Thus, ripping software that parses the control data, in order to find addressed content data, typically fails to copy discs protected in this way.

Embodiments of the present invention aim to provide alternative or improved anti-ripping solutions for optical discs and, in particular, DVD-Video optical discs and the like. References to DVD herein typically relate specifically to DVD-Video discs. However, unless otherwise indicated, the principles apply equally to other DVD formats, such as DVD-Audio, and, more broadly, to other formats of optical disc product, such as Blu-ray and HD-DVD optical discs. Indeed, nowadays, it is becoming commonplace for content to be stored on, and replayed from, other kinds of media, such as hard disc and flash memory, or downloaded across a network or via satellite to playback on a set top player or the like. Accordingly, unless otherwise indicated, or unless the context specifically demands, aspects and embodiments of the present invention apply equally to any kind of media content, media content storage, media content transmission, data format and/or playback format.

### SUMMARY OF THE INVENTION

According to a first aspect, the present invention provides a media product carrying, in a data area, presentation data, navigation data and read barriers, the navigation data providing a plurality of selectable playback paths and providing selection logic for selecting a playback path during playback of the product, wherein at least one selectable playback path encounters a read barrier and at least one other selectable playback path does not encounter a read barrier.

Generally, presentation data may include any kind of audio and/or visual content data that may be played back, or presented, by a media player. Likewise, navigation data may include any kind of addressing and/or control data that influences how, or which parts of, the presentation data may be played. A read barrier may include any kind of logical or physical construct that is arranged or adapted to hinder a read operation. Preferably a read barrier prevents a read operation, or at least causes a delay compared with an unhindered read operation.

The media product may incorporate at least one valid playback path that yields an expected correct playback of at least some presentation data. For example, the media product may incorporate two or more valid playback paths that yield(s) an expected correct playback of at least some presentation data.

The media product may incorporate at least one invalid playback path that yields an invalid playback operation of the media product. For example, the media product may incorporate two or more invalid playback paths that yield an invalid playback operation of the media product.

The media product may incorporate at least one invalid playback path that encounters a read barrier. For example, the media product may incorporate two or more invalid playback paths that each encounters a read barrier.

At least one read barrier may be in or between regions containing presentation data. The presentation data may be subdivided into addressable portions. Then, a read barrier may be incorporated into an addressable portion of presentation data. In addition, or alternatively, a read barrier may be incorporated between consecutive portions of presentation data. In any event, at least one read barrier may be in or between regions containing navigation data.

The navigation data may comprise a first choice component having an option to select a second choice component, from plural selectable alternative second choice components, on the basis of a function of the selection logic, wherein at least one of the alternative second choice components is in, or leads to playback of, a playback path which encounters a read barrier.

The navigation data may comprise a choice component having an option to select a playback sequence of presentation data, from a plurality of selectable playback sequences, on the basis of a function of the selection logic, wherein at least one of the sequences is in a playback path which encounters a read barrier.

A choice component may comprise a menu item having one or more user-selectable playback options, and at least one playback option incorporates the selection logic.

The selection logic may select a playback path on the basis of a runtime calculation. For example, the selection logic may select a playback path on the basis of a function of one or more of: a random value as provided by a random number generator; a value dependent on the time when playback options are selected; a value that is specific to a device on which the playback is occurring; and a value that is specific to a selected navigational structure and/or playback path of the product.

The selection logic may in addition, or alternatively, be adapted to select a playback path that yields an invalid playback operation of the media product if certain data in the data area has been modified by a ripping operation. For example, the selection logic may be adapted to select a playback path that encounters a read barrier if certain data in the data area has been modified by a ripping operation.

The navigation data may comprise a plurality of navigation objects, and the selection logic may then be associated with at least a first navigation object, whereby progress from the first navigation object to another navigation object is controlled by the selection logic. For example, at least one instance of the selection logic may comprise a multi-way branch, which determines which navigation object, of a plurality of alternative navigation objects, to navigate to.

According to a further aspect, the present invention provides an authentic media product comprising a media product according to the first aspect of the present invention, wherein playback of the product does not encounter a read barrier.

According to another aspect, the present invention provides a counterfeit media product comprising a media product according to the first aspect of the present invention, wherein playback of the product may encounter a read barrier.

According to a yet another aspect, the present invention provides an optical disc product, for example a DVD product, comprising a media product as descried hereinbefore.

Further aspects and embodiments of the present invention will become apparent from the following description, claims and drawings.

### BRIEF DESCRIPTION OF THE DRAWINGS

One or more embodiments of the present invention will now be described, by way of example only, with reference to the accompanying drawings, of which:

FIG. 1 is a diagram of an exemplary DVD-Video navigational structure;

FIG. 2 is a diagram of part of a menu portion of a navigational structure, which has been modified in accord with an embodiment of the present invention;

FIG. 3 is a diagram of a content playback portion of a navigational structure, which has been modified in accord with an embodiment of the present invention;

FIG. 4 is a diagram of part of a menu portion of a navigational structure, which has been modified in accord with an alternative embodiment of the present invention;

FIG. 5 is a table listing various system parameters (SPRM) of a DVD player;

FIG. 6 is a diagram of apparatus suitable for authoring audiovisual content; and

FIG. 7 is a diagram of a DVD-Video product containing both navigational data and audiovisual content.

### DETAILED DESCRIPTION OF ONE OR MORE EMBODIMENTS

The following description relates specifically to DVD-Video embodiments of the present invention. However, the principles taught hereinafter are in no way limited to DVD-Video implementations. The skilled person will appreciate that certain specific details are provided hereinafter in order to demonstrate embodiments of the present invention, whereas certain other specific, well known technical details have been omitted purely in order to maintain a concise description and so as not to obscure important features of the present invention.

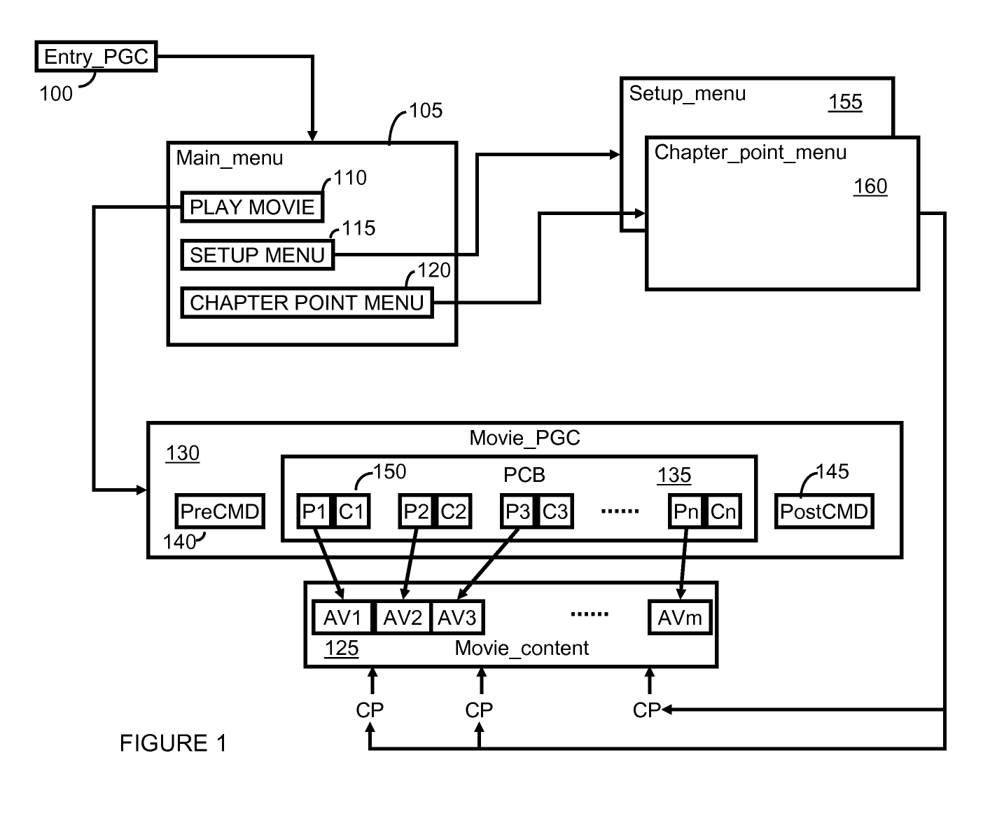

The diagram in FIG. 1 illustrates a high-level, logical navigation structure of a typical, exemplary, DVD-Video disc. As shown, when the DVD is inserted into a DVD player, playback initiates an entry-program chain object, Entry_PGC 100, which is the starting point for navigation. The Entry-PGC 100 automatically directs playback to a ‘Main’ menu object, Main_menu 105, which is shown to have three menu button options. A first button option, “PLAY MOVIE” 110, causes the DVD player to start playback from the beginning of the main content item, Movie_content 125, which is, for example, a movie—by directing playback to a Movie PGC object, Movie_PGC 130.

As illustrated in FIG. 1, the Movie_PGC 130 typically contains a program control block, PCB 135, which contains an ordered list of pointers P1, P2, . . . Pn, which dictates the replay order of cells AV1, . . . AVm, which make up the main content object, Movie_content 125. The replay order of the cells is usually sequential (but need not be, according to certain embodiments of the present invention, as described in more detail hereinafter). In addition to the pointers, the PGC 130 may contain navigation commands including pre-commands, PreCMD 140, which precede the cell pointers, post commands PostCMD 145, which follow the cell pointers, and cell commands 150 (C1, C2 . . . Cn), which execute after the respective cell has been played.

Navigation commands, which are similar to CPU instructions that execute on a typical personal computer, can be used to vary the playback behaviour of a DVD product.

The second button option, “SETUP MENU” 115, of Main_menu 105 redirects playback to a setup menu object, Setup_menu 155, which typically has options (not shown) for varying playback parameters of the DVD player (for example, by selecting spoken language, switching sub-titles on and off etc.). The third button option, “CHAPTER POINT MENU” 110, of Main_menu 105 redirects playback to a chapter point menu object, Chapter_point_menu 160, from where the movie can be started at various chapter points (CP), of which three are illustrated in the Movie_content object.

In general, DVD menu objects comprise a static display image and one or more menu buttons, which can change appearance when they are selected and activated. The menu buttons can be navigated between using arrow keys on a standard DVD player remote controller. More elaborate menu objects, having dynamic displays, animated menu buttons and an audio track, are also known. Each menu button has associated with it, programmed into the DVD control code, a respective command to enact a specific navigation or control function. Typical functions relate to configuring the operation of the DVD player, selecting other menus and playing back one or more items of content contained on the DVD itself. DVD menus of this kind are familiar both to DVD authors and DVD users.

The diagram in FIG. 1 illustrates a number of playback paths. One playback path comprises selecting the PLAY MOVIE 110 button option on Main_menu 105. This directs playback to the Movie_PGC 130, which, in turn, starts playback of the movie from the first cell, AV1, of the Movie_content 125. Other playback paths are permissible by selecting one of the chapter points, CP, to start playback of the movie from different respective start points, via the Chapter_point_menu 160.

According to embodiments of the present invention, at least one, typically several and potentially all navigational objects (for example the three menu objects in the foregoing example) is or are replaced by multiple alternative versions. In some embodiments, each link from one navigational object to another can then become a multi-way branch, where the destination location in each case is determined through an arithmetic or logical calculation. For example, one navigational link in the foregoing example is the change in execution path from the Entry_PGC 100 to the Main_menu 105, as will now be described.

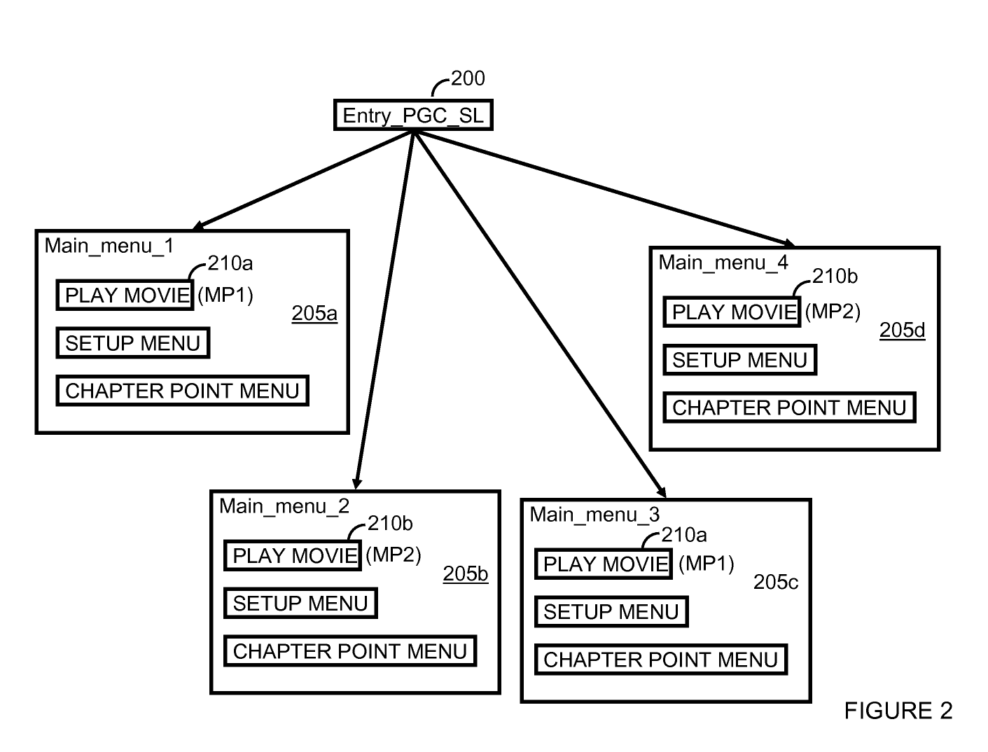

The diagram in FIG. 2 illustrates part of a high-level, logical navigation structure of a DVD product according to an embodiment of the present invention. The structure includes a modified entry PGC, Entry_PGC_SL 200, and the single main menu object of the diagram in FIG. 1 has been replaced by four main menu objects, denoted Main_menu_1-Main_menu_4 (205a-205d). The modified entry PGC, Entry_PGC_SL 200, includes additional selection logic (SL). The selection logic controls Entry_PGC_SL 200 to direct playback automatically to a particular main menu object, depending on certain criteria. The selection logic may be included in a pre or post command of the entry PGC. However, the selection logic can, in principle, be held in any appropriate DVD data structure location that stores executable navigation commands. To a user of the DVD, there would typically be no apparent distinction, in terms of video and/or audio playback presentation, between any of the main menu objects. However, the operation of the different menu objects is different, as will now be described.

Although only four menus and branches are illustrated, this is for simplicity of description only, and, in practice, a much greater number of branches may be implemented in order to increase the effectiveness of the technique.

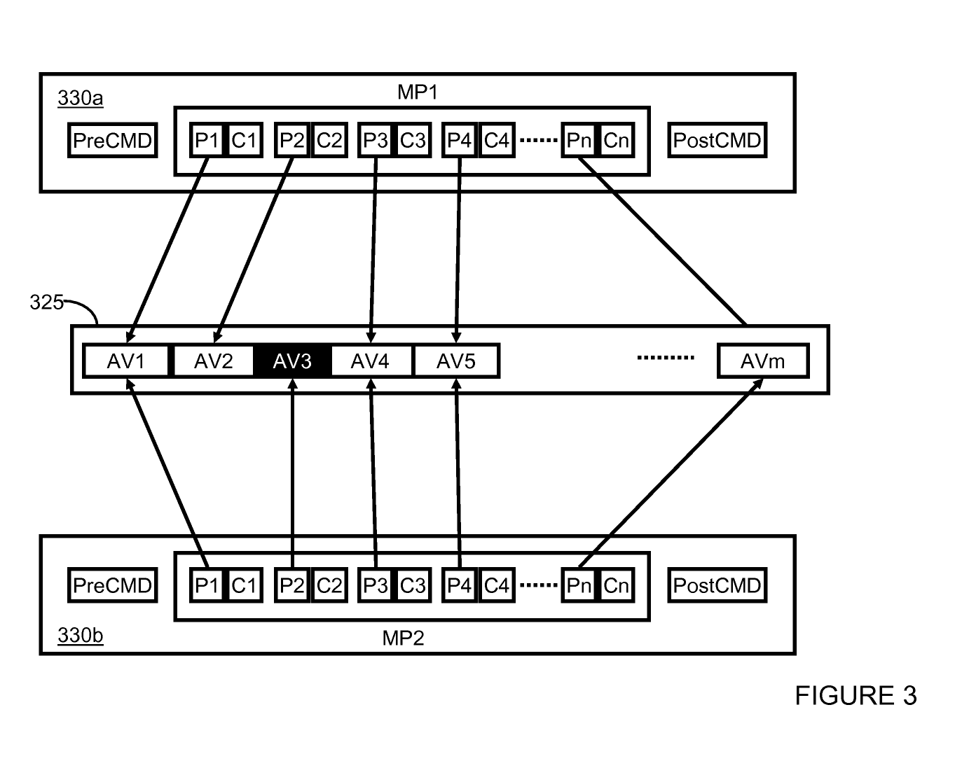

By way of example, it is assumed that Main_menu_1 205a and Main_menu_3 205c correspond to, or are in, valid playback paths, whereas Main_menu_2 205b and Main_menu_4 205d correspond to, or are in, invalid playback paths. The difference in playback path between the menu objects is determined by the PLAY MOVIE button options in each menu object, which have respectively modified button commands. As shown, the PLAY MOVIE button options 210a in Main_menu_1 and Main_menu_3 direct playback to Movie_PGC_1 (MP1) and the PLAY MOVIE button options 210b in Main_menu_2 and Main_menu_4 direct playback to Movie_PGC_2 (MP2). Movie_PGC_1 and Movie_PGC_2 are illustrated in the diagram in FIG. 3.

It is often beneficial, though by no means essential, to include plural valid playback paths, in order to make it more difficult for ripping software to discern between valid and invalid playback paths.

The diagram in FIG. 3 illustrates two alternative PGC objects, MP1 330a and MP2 330b, which both point to a Movie_content object 325, which is shown to have cells AV1-AVm. According to the present embodiment, both PGC objects are stored on a DVD product. As shown, the first four cell pointers of MP1 refer to cells AV1, AV2, AV4 and AV5 of the Movie_content object 325, whereas the first four cell pointers of MP2 refer to cells AV1, AV3, AV4 and AV5 of the Movie_content object 325. The Movie_content object 325 includes cell AV3 (identified in reverse video), which contains a read barrier (not particularly shown). According to the present embodiment, the read barrier is a logical read barrier of the kind described in the aforementioned MV1 patent application. Of course, the barrier could be physical as in the aforementioned Imation patent application. However, any kind of barrier, which is likely to cause a read error, would suffice, according to embodiments of the present invention.

Accordingly, playback of the Movie_content object 325 via MP1 330a will lead to uncorrupted, correct playback of the content item. In contrast, playback of the Movie_content object 325 via MP2 330b will lead to corrupted playback of the content item, as the read operation would try to access AV3. Likewise, ripping software, which parses the navigation structure of a DVD, would tend to fail when MP2 is accessed, and there is no obvious indicator to the ripping software that MP2 should not be accessed.

Selection logic for selecting one of the four menus of FIG. 2 may be in accord with the following DVD player navigation command sequence:

LNK Main_menu_1 GPRM1 EQ 39
LNK Main_menu_2 GPRM1 EQ 11751
LNK Main_menu_3 GPRM1 EQ 4283
LNK Main_menu_4

This command sequence provides a multi-way branch operation, which assumes that a runtime value is calculated and stored in general parameter register 1 (GPRM1) of the DVD player. The first line of the code links to (or directs playback to play) Main_menu_1 205a if GPRM1 equals ‘39’, the second line of the code links to Main_menu_2 205b if GPRM1 equals ‘11751’, the third line of the code links to Main_menu_3 205c if GPRM1 equals ‘4283’ and the final line of the code links to Main_menu_4 205d if the tests in the foregoing three lines of code have been negative. Hence, if it is the case that 39 and 4283 are the only valid values for the calculation performed, and one of these two values is in GPRM1, then the selection logic causes playback to jump to Main_menu_1 205a or Main_menu_3 205c, and correct playback resumes.

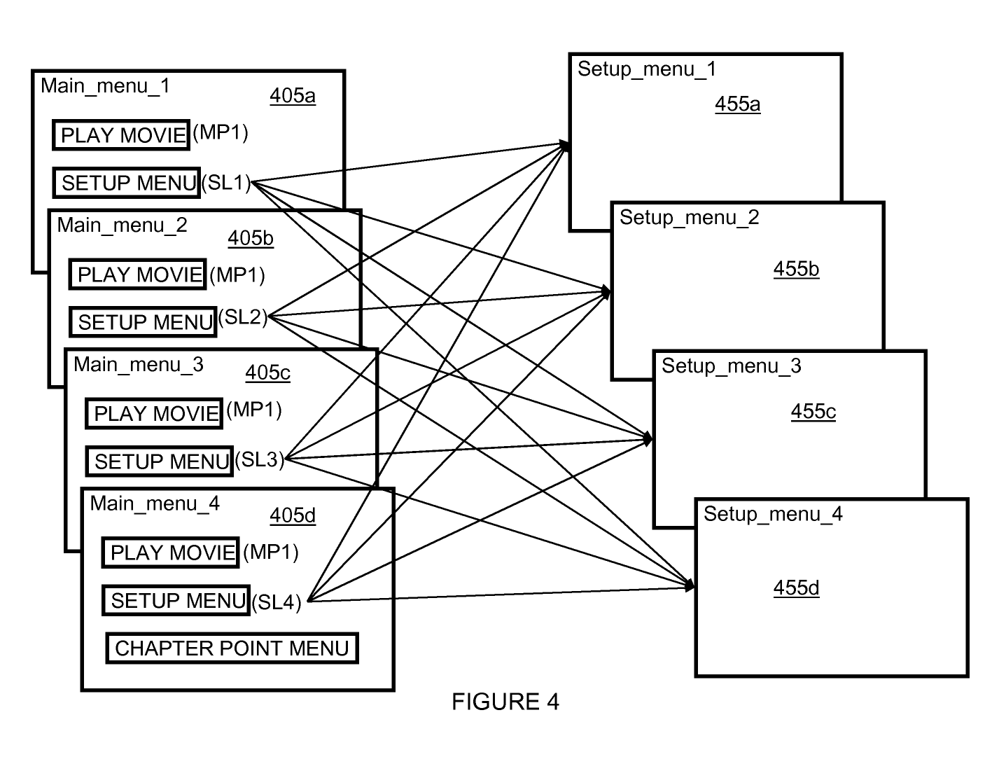

The diagram in FIG. 4 illustrates a further navigational structure providing additional navigation paths, some of which may be valid playback paths and others of which may be invalid playback paths, according to an embodiment of the present invention. In this example, a single main menu object has been replaced by four main menu objects, Main_menu_1-Main_menu 4, 405a-405d respectively, which may be accessed according to the preceding example or in other similar or, indeed, different ways. In addition, in this example, a single setup menu object has been replaced by four setup menu objects, Setup_menu_1-Setup_menu 4, 455a-455d respectively. In this example, it is assumed that Setup_menu_3 455c and Setup_menu_4 455d correspond to, or are in, valid playback paths and Setup_menu_1 455a and Setup_menu 2 455b correspond to, or are in, invalid playback paths.

The SETUP MENU button option in each main menu object includes selection logic, SL1-SL4, which causes redirection to one of the setup menu objects in accord with certain criteria. The selection logic incorporates a calculation to select the next navigational object (that is, a setup menu object), which will be selected if the user selects the setup menu button option of any of the main menu objects. As shown, in theory, each of the setup menu objects can be selected by a SETUP MENU button from each main menu object.

The selection logic of FIG. 4 is arranged so that the playback path will move to Setup_menu_3 455c or Setup_menu_4 455d under some circumstances and to Setup_menu_1 455a and Setup_menu_2 455b under other circumstances. In one variant of the embodiment, Setup_menu_1 and Setup_menu_2 may include read barriers in a part of the respective data structure of the menu object, whereby playback, or a ripping process that tries to access the respective menu object, will fail. In another variant of the embodiment, the playback menu objects may each modify a playback parameter or state, for example by setting a value of a particular GPRM, which is used by further selection logic later on in the playback path to determine which of many optional movie PGC objects is selected to play a movie. As before, one or more PGC objects may cause playback to access a read barrier, whereas other PGC objects may avoid read barriers. Of course, some PGC objects may themselves include read barriers.

More generally, selection logic can be added in each instance where a navigation structure progresses from one object, for example a menu object or a PGC object, to another object, for example a menu object, a PGC object or a content object. For example, selection logic may be included in menu button options, PGC pre or post commands, and cell commands following cell pointers, or in any combination of the foregoing options. Such selection logic can be included to greatly increase the number of playable playback paths, some of which are valid and some of which are invalid, in terms of whether a read operation will encounter a read barrier. The inclusion of these additional playback paths means that it is not easy to identify, from a static analysis of a DVD product, which playback path is the correct playback path, so that ripping software may inadvertently process an invalid path, which may contain barriers. In addition, having multiple valid paths means that it is not easy to identify, from a static analysis or even from an emulation of playback, which playback paths are valid, since even the actual valid path can vary between each playback invocation, potentially leading ripping software to deduce that certain valid paths are actually invalid paths. In this case, ripping software may remove such valid paths from the copied data, which will result in playback errors when a copy is played in a DVD player.

Embodiments of the present invention offer several benefits. First, as in other anti-ripping solutions, read barriers can be introduced into a DVD product in order to frustrate ripping software that reads content sequentially. In addition, as in, for example, the MV2 prior patent application, additional navigation or control content can be added, in order to frustrate ripping software that parses navigation content in order to distinguish between content that is accessed and content that is not accessed.

However, unlike in prior anti-ripping solutions, the additional navigation content is accessible during playback due to the addition of selection logic. This feature of embodiments of the present invention offers additional benefits. For example, it is known that some of the more-advanced ripping software is able to read a DVD and re-arrange one or both of the navigation structure and content data in order to copy the content data. This kind of ripping technique can be useful if an aim of the ripping software is to extract selected content, for example the main movie content, and ignore other, less-important material (for example, previews of other films or adverts).

In other cases, the ripping software may be arranged to copy content from a double sided and/or dual layer DVD product onto a single sided and/or single layer DVD product, or even onto a relatively low capacity CD-ROM product. This can sometimes be achieved, for example, by reading the movie content and applying a higher compression ratio to the content, in order to fit it into a smaller data area. In any event, such advanced ripping software routinely re-organises either or both of the navigation structure (for example, the PGC arrangement) and the content structure (for example, the cell arrangement). Therefore, even if advanced ripping software can determine which parts of the content are required while avoiding the barriers, providing selection logic, which tests the integrity of the navigation structure according to embodiments of the present invention, increases the likelihood that a copied DVD product will not be playable, as will now be described. Indeed, such integrity tests may be applied in the absence of other features, such as read barriers, to frustrate the playback of copied DVD product and the like.

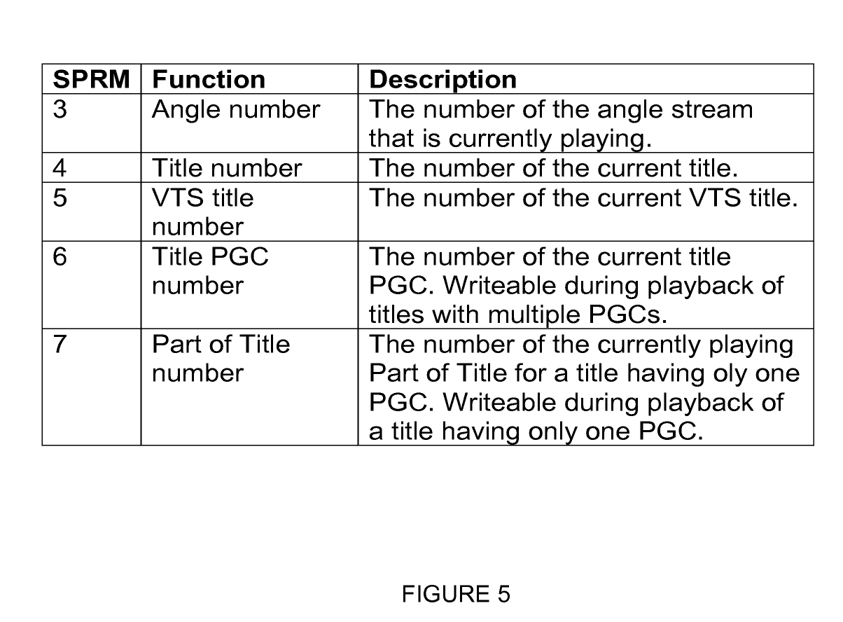

Embodiments of the present invention are able, in effect, to overcome tampering of a DVD product, for example by ripping software that alters the navigation or content structure for one of the aforementioned reasons. DVD players have a number of system parameter registers, or SPRM, which can be read and, in some cases, written to during DVD playback. A number of the SPRM registers are updated by the playback processor of a player during playback of a DVD in order to track the playback state of the DVD. Some of these registers are illustrated in the table in FIG. 5.

In order to detect tampering of a DVD by ripping software, certain SPRM values can be interrogated and compared with the expected value in each case at a certain point in the execution or playback of a navigational structure. For example, on DVD, as illustrated in FIG. 5, SPRM6 stores the current PGC number during playback. Therefore, in any PGC, selection logic may be included to confirm that the PGC number is as expected (that is, according to an original structure). For example, in a PGC number 867 the following DVD player navigation command sequence may be incorporated in a PGC pre-command:

| | |
|---|---|
| MOV GPRM1 SPRM6 | |
| LNK location1 GPRM1 EQ 25 | (invalid playback path) |
| LNK location2 GPRM1 EQ 867 | (valid playback path) |
| LNK location3 GPRM1 EQ 2166 | (invalid playback path) |
| LNK location4 | (invalid playback path) |

The first line of the command sequence reads the value of SPRM6 and writes the value into GPRM1. The second line of the code links to (or directs playback to play) location1 if the value of GPRM1 equals 25, the third line of the code links to location2 if the value of GPRM1 equals 867, the fourth line of the code links to location3 if the value of GPRM1 equals 2166 and the final line of the code links to location4 if the tests in the previous lines of code have failed. The consequence of this code is that, provided that the DVD structure is unmodified (more specifically, that this PGC object is still numbered 867), then valid execution will pass to “location2”, which is a valid location (for example, in a PGC object), otherwise execution will continue elsewhere, corresponding to an invalid path (for example, a dummy PGC or dummy content data).

This same principle may be extended over multiple PGC objects. For example, in one PGC, numbered 37 say, the following code may be included:

### MOV GPRM1 SPRM6

Thus, this command sequence stores the current PGC number (which should be 37 if the DVD is unmodified) in GPRM1. During playback of a later PGC (numbered 234 in the following example), the following code appears:

MOV GPRM2 SPRM6
MUL GPRM1 GPRM2
LNK location1 GPRM1 EQ 33
LNK location2 GPRM1 EQ 654
LNK location3 GPRM1 EQ 8658
LNK location4 GPRM1

The first line of the code reads and copies the value of SPRM6 into GPRM2 and the second line of the code multiplies the value of GPRM1 with the value of GPRM2 and stores the result in GPRM1. The behaviour of the additional lines of code is analogous to previous examples, to create a multi-way branch operation.

In this example, GPRM1 stores the value 37 (from the previous PGC) and GPRM2 stores the value 234 (from the current PGC). A branch is made on the result of these two values multiplied together, and, therefore, the correct destination corresponds to location3, which may be a cell pointer in the current PGC or a different PGC, which, in either case, is a valid playback path. Any re-organisation of the PGC structure by a ripping operation, will lead to attempted playback of a different playback path.

Thus, it can be appreciated that selection logic according to embodiments of the present invention can be included to frustrate or circumvent copying involving modifying or re-arranging the navigation and/or content data on a DVD product.

In any event, selection logic may test various parameters of a DVD product or a DVD player in order to select a particular playback path. For example, runtime calculations may be based on functions of one or more of the following:
a. Random values as provided by a random number generator (such as the DVD-Video RND function);
b. Values dependent on the time when the user selects menu options (for example, using the DVD-Video timer feature);
c. Values that are specific to the device on which the playback is occurring (such as values of a number of the SPRM registers on DVD-Video that supply region information, audio and video configuration, country code in SPRM 20, 15, 14 and 12 respectively); and
d. Values that are specific to the navigational structure and playback path of the disc (such as the values of a number of the SPRM registers on DVD-Video that define the active Title, VTS, PGC and PTT in SPRMs 4, 5, 6 and 7 respectively).

Options a. and b. may be applied to generate a pseudo-random selection between multiple valid playback paths, if the DVD structure has not been tampered with, or between multiple invalid playback paths, if the DVD structure has been tampered with. In other words, even in an authentic DVD product, different valid playback paths may be selected on each, otherwise identical, legitimate playback operation. Such variation of valid or invalid playback path between playback operations, on the basis of runtime calculations, would tend to make it extremely difficult for ripping software to establish, on the basis of a static analysis of the respective DVD product, or even on the basis of a playback emulation of the DVD product, which playback paths are valid and which playback paths are invalid.

Moreover, even if ripping software is able to emulate successfully a playback operation of the DVD product, and create a counterfeit DVD product, it is likely that a majority of playback operations of the counterfeit DVD product would fail. This is because the selection logic, which is built into the navigation structure and would be copied, would still carry out a pseudo-random path selection operation. If only one path has been copied (for example, that being a path that was successfully emulated by ripping software) then each playback that attempts to select a different playback path would fail.

Clearly, the more valid alternative playback paths there are, the more effective a DVD product would be in defeating DVD emulation ripping software, as the probability of pseudo-randomly selecting the one emulated, counterfeit playback path would be inversely proportional to the number of valid playback paths.

In relation to option c. playback of the disc in a player that has, for example, a region code that does not designate the specific region for which the disc was originally authored, will result in the selection of an invalid path, causing playback errors when the copy is played in a set-top device.

It will be appreciated that the calculations illustrated in the above examples are quite simple, and, in practice, more convoluted calculations extending over multiple steps of the navigation paths, and more extensive branching structures, would be implemented. In addition, or alternatively, in other embodiments of the present invention, there may be more alternative PGC objects, more read barriers (placed in navigation and/or content structures) and/or multi-way branches may include far more tests. Obviously, for non-DVD-Video embodiments, there will be many other different tests that could be applied in a similar way.

In the context of DVD-Video, a playback path has been illustrated in the foregoing examples in terms of playing back a simple sequence of cells, under the control of a typical PGC. The sequence can be in the order in which the cells are arranged or, instead, the sequence can be jumbled, either or both in terms of the PGC cell pointer order and the cell order, so as to increase the difficulty faced by ripping software. Jumbling cells in this way, in order to obscure a correct playback path, is described in detail in the applicant's co-pending international patent application WO2004/109680, the entire contents of which are hereby incorporated herein by reference. Alternatively, one or more playback paths may be defined by switching between parallel streams of generally similar content, for example using multi-angle video structures of the kind that are normally associated with providing multiple camera angles. Such an arrangement is described in applicant's co-pending patent application WO2004/109679, the entire contents of which are hereby incorporated herein by reference. Of course, these principles may be applied also to formats other than DVD-Video.

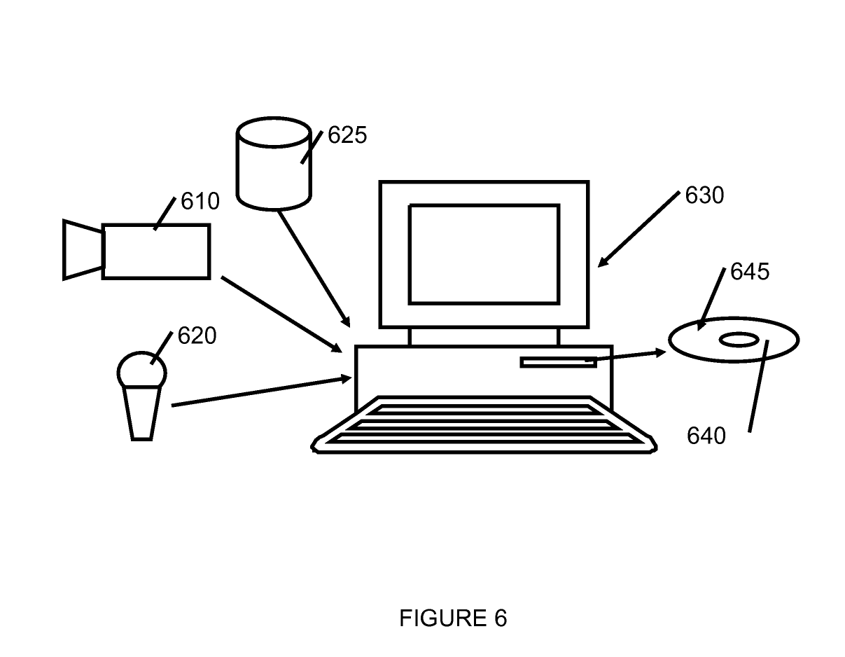

FIG. 6 shows an exemplary authoring apparatus as may be employed in preferred embodiments of the present invention. The authoring apparatus includes a computing platform such as a client-server computer system, or a stand-alone personal computer, 630. Optionally, raw audio and video data are received, such as through a camera 610 and a microphone 620, or are provided from other sources such as a file storage device 625, or are created within the authoring apparatus such as by image and sound capture and creation software. The raw content data may include video clips, audio clips, still picture images, icons, button images and other visual content to be presented onscreen. The content is suitably in the form of MPEG, JPEG or bitmap encoded files, but may take any suitable format.

Original audiovisual data can take any form such as a movie, or a company presentation, or a quiz game, amongst many other possibilities. The computer 630 acting as the authoring apparatus creates the desired audiovisual product using the procedures that have been described herein. The computer 630 writes the audiovisual product 645 onto a storage medium such as a hard disk drive within the computer 630 or onto an optical disk 640.

In the context of the present invention, the author would in addition to the normal authoring steps define selection logic to be associated with the navigation structures, provide alternative navigation structures that can be selected depending on the outcomes of processing the selection logic and introduce read barriers into additional content or between existing content items.

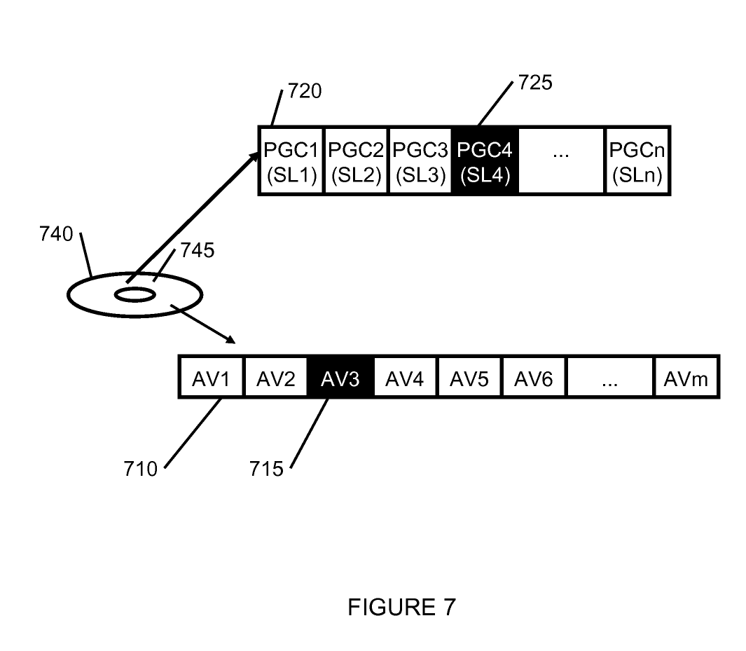

FIG. 7 shows the general structure of the audiovisual product 740, for example a DVD product. The DVD product 740 includes a plurality of cells 710, in this case represented by cells AV1, AV2 . . . AVm. Each cell 710 contains a short section of audiovisual data. The cells are played in sequence, typically one after the other, in order to deliver the intended audiovisual representation, under control of a playback sequence instruction 720. The sequence instructions 720, as shown in FIG. 7, are separate from the cells 710. Suitably, the cells 710 and the sequence instructions 720 are each allocated to structure locations within the audiovisual product 740, so as to enable navigation between instructions 720 and from instructions 720 to cells 710.

In the preferred example of DVD-Video specification data, the cells 710 are played in sequence through their inclusion by reference in programs (PGs), which are in turn organised into program chains (PGCs). In FIG. 7, the sequence instructions 720 are represented by program chains PGC1, PGC2 . . . PGCn. Each PGC has respective selection logic (SLn), for selecting optional playback paths. Preferably, each cell 710 contains at least one video stream, at least one audio stream, and/or at least one sub-picture stream. Menu information is included in navigation data, for example in so-called navigation packs, which are interleaved with the video and audio streams in the usual known way.

The diagram in FIG. 7 also identifies a cell 715 and a PGC 725, which each contain a read barrier. As already explained, read barriers can be included in almost any data region of the optical disc, in order to assist in circumventing copying.

As the reader will appreciate, there are many different ways—far more than can be described herein—in which embodiments of the present invention may be implemented. Accordingly, only the claims appended hereto, as influenced by any broadening purposive construction or equivalence doctrine or theory, should be used to limit the scope of the invention.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A media product carrying, in a data area, presentation data, navigation data and read barriers, the navigation data providing a plurality of selectable playback paths and providing selection logic for selecting a playback path during playback of the product, wherein at least one selectable playback path encounters a read barrier and at least one other selectable playback path does not encounter a read barrier.

2. A media product according to claim 1, incorporating at least one valid playback path that yields an expected correct playback of at least some presentation data.

3. A media product according to claim 1, incorporating two or more valid playback paths that yield(s) an expected correct playback of at least some presentation data.

4. A media product according to claim 1, incorporating at least one invalid playback path that yields an invalid playback operation of the media product.

5. A media product according to claim 1, incorporating two or more invalid playback paths that yield an invalid playback operation of the media product.

6. A media product according to claim 1, incorporating at least one invalid playback path that encounters a read barrier.

7. A media product according to claim 1, incorporating two or more invalid playback paths that each encounters a read barrier.

8. A media product according to claim 1, comprising at least one read barrier in or between regions containing presentation data.

9. A media product according to claim 1, wherein the presentation data is subdivided into addressable portions.

10. A media product according to claims 9, wherein a read barrier is incorporated into an addressable portion of presentation data.

11. A media product according to claim 9, wherein a read barrier is incorporated between consecutive portions of presentation data.

12. A media product according to claim 1, comprising at least one read barrier in or between regions containing navigation data.

13. A media product according to claim 1, wherein the navigation data comprises a first choice component having an option to select a second choice component, from plural selectable alternative second choice components, on the basis of a function of the selection logic, wherein at least one of the alternative second choice components is in, or leads to playback of, a playback path which encounters a read barrier.

14. A media product according to claim 1, wherein the navigation data comprises a choice component having an option to select a playback sequence of presentation data, from a plurality of selectable playback sequences, on the basis of a function of the selection logic, wherein at least one of the sequences is in a playback path which encounters a read barrier.

15. A media product according to claim 13, wherein a choice component comprises a menu item having one or more user-selectable playback options, and at least one playback option incorporates the selection logic.

16. A media product according to claim 1, wherein the selection logic selects a playback path on the basis of a runtime calculation.

17. A media product according to claim 1, wherein the selection logic selects a playback path on the basis of a function of one or more of: a random value as provided by a random number generator; a value dependent on the time when playback options are selected; a value that is specific to a device on which the playback is occurring; and a value that is specific to a selected navigational structure and/or playback path of the product.

18. A media product according to claim 1, wherein the selection logic is adapted to select a playback path that playback path that yields an invalid playback operation of the media product if certain data in the data area has been modified by a ripping operation.

19. A media product according to claim 1, wherein the selection logic is adapted to select a playback path that encounters a read barrier if certain data in the data area has been modified by a ripping operation.

20. A media product according to claim 1, wherein the navigation data comprises a plurality of navigation objects, and the selection logic is associated with at least a first navigation object, whereby progress from the first navigation object to another navigation object is controlled by the selection logic.

21. A media product according to claim 20, wherein at least one instance of the selection logic comprises a multi-way branch, which determines which navigation object, of a plurality of alternative navigation objects, to navigate to.

22. A media product according claim 1 including at least one logical read barrier.

23. A media product according to claim 1 including at least one physical read barrier.

24. A media product carrying, in a data area, presentation data and navigation data, the navigation data providing a plurality of selectable playback paths and providing selection logic for selecting a playback path during playback of the product, wherein the selection logic is arranged to select a playback path according to a variable playback condition, whereby different playback paths can be selected during different playback operations.

25. An authentic media product comprising a media product according to claim 1.

26. A counterfeit media product comprising a media product according to claim 1, wherein playback of the product may encounter a read barrier.

27. An optical disc product comprising a media product according to claim 1.

28. A DVD product comprising a media product according to claim 1.

29. Media image data embodying a media product according to claim 1.

30. A storage medium storing media image data according to claim 29.

31. A method of playing a media product according to claim 1, the method including the step of selecting for playback a playback path that encounters a read barrier if certain data in the data area has been modified by a ripping operation.

32. A method of playing a media product according to claim 1, the method including the step of selecting for playback a playback path that avoids a read barrier.

33. A method of playing a media product, the media product carrying, in a data area of the product, presentation data, navigation data and read barriers, the navigation data providing a plurality of selectable playback paths and providing selection logic for selecting a playback path during playback of the media product, wherein at least one selectable playback path encounters a read barrier and at least one other selectable playback path does not encounter a read barrier, the method including the step of selecting for playback a playback path that encounters a read barrier if certain data in the data area has been modified by a ripping operation.

34. A method of playing a media product, the media product carrying, in a data area of the product, presentation data and navigation data, the navigation data providing a plurality of selectable playback paths and providing selection logic for selecting a playback path during playback of the media product, wherein at least one selectable playback path yields an expected correct playback operation of the media product and at least one other selectable playback path yields an incorrect playback operation of the media product, the method including the step of selecting for playback a playback path that yields an incorrect playback operation of the media product if certain data in the data area has been modified by a ripping operation.

35. A method of authoring a media product including providing, in a data area, presentation data and navigation data, and, in addition, providing read barriers and selection logic in the data area, the navigation data providing a plurality of selectable playback paths and the selection logic being arranged to select a playback path during playback of the product, wherein at least one selectable playback path is arranged to encounter a read barrier and at least one other selectable playback path is arranged not to encounter a read barrier.
